(19) United States
(12) Patent Application Publication
(10) Pub. No.: US 2023/0012718 A1
(43) Pub. Date: Jan. 19, 2023

(54) Teaser

(71) Applicant: Vheam Pty Ltd, Buderim (AU)

(72) Inventor: Patrick Van Heerden, Buderim (AU)

(73) Assignee: Vheam Pty Ltd

(21) Appl. No.: 17/864,159

(22) Filed: Jul. 13, 2022

(30) Foreign Application Priority Data
Jul. 14, 2021 (AU) 2021902157

(51) Int. Cl. A01K 85/01

(52) U.S. Cl. CPC A01K 85/015

(57) ABSTRACT

A trolling teaser for trolling and attracting fish, the teaser comprising: an elongate body extending between a frontal end and a rear end, the front end wherein the front end comprises a tethering attachment to tether the body to a towline and allow the teaser to be towed; one or more light sources mounted to the body for radiating light and attracting fish; and, a light source controller housed within an internal volume of the body for controlling operation of the at least one light source.

### TECHNICAL FIELD

The present invention relates to a teaser. More particularly, a fish teaser for use during fishing.

### BACKGROUND

A teaser is a device towed behind a boat which is used to attract or lure fish to a specific area. Lures and/or hooks are positioned in the specific area for catching the attracted fish. The teaser aims to attract or lure fish by mimicking a fish in distress, or a school of bait that in turn attracts, teases and works a fish up to trigger an aggressive bite on the nearby lures or baited hooks.

The teaser itself is not a catching device. The actual catching device is the lure and/or hooks. However, typically, the more fish lured or attracted to an area, the higher the chance of catching fish.

One known teaser uses a body covered in reflective panelling towed behind a boat to attract fish. The reflective panelling reflects sunlight to mimic a fish in distress. One problem with this known teaser, however, is that when there is little to no sunlight, for example on an overcast or rainy day, the reflective panels have little to no light to reflect and thus the known teaser is not effective. Another problem with this known teaser is that there is limited control over which parts of the water sphere surrounding the teaser receives the reflected light.

In view of the above, there is a need for a product which may at least partially overcome the above-mentioned disadvantage or provide a consumer with a useful or commercial choice.

Any references to methods, apparatus or documents of the prior art are not to be taken as constituting any evidence or admission that they formed, or form part of the common general knowledge.

### SUMMARY OF INVENTION

In one aspect, the present invention resides in a trolling teaser for trolling and attracting fish, the teaser comprising:

an elongate body extending between a frontal end and a rear end, the front end wherein the front end comprises a tethering attachment to tether the body to a towline and allow the teaser to be towed;

one or more light sources mounted to the body for radiating light and attracting fish; and,

a programmable light source controller housed within an internal volume of the body for controlling operation of the at least one light source.

Advantageously, the at least one light source may be programable to flash at different rates, patterns, sequences and/or intensities, predetermined and/or randomly.

In some embodiments, the at least one light source is adapted to mimic bait or other predatory fish. For example, bait fish and/or bait balls.

In some embodiments, the microprocessor includes instructions which instruct the at least one light source to flash in a predetermined pattern, at a predetermined rate, and/or at a predetermined intensity. In alternative embodiments, the microprocessor includes instructions that cause the at least one light source to flash randomly.

In some embodiments, the microprocessor is adapted to instruct the at least one light source to operate in one or more modes.

In some embodiments, the teaser is adapted to rise to the surface of a body of water when not being towed. In most embodiments, the teaser is positively buoyant. In most embodiments the centre point of buoyancy is above the centre of mass of the teaser. Advantageously, if the teaser is separated from the boat, then the teaser will float to the surface of the body of water which facilitates easy retrieval. The body of the teaser is positively buoyant in water when the teaser is not being towed by the tow line and the tethering attachment attaches the tow line at an attachment location to substantially lower the body of the teaser into water when the teaser is being towed by the towline behind a vessel pulling the towline. The tethering attachment enables attachment of the towline at a plurality of attachment locations thereby allowing the body of the teaser to be towed by the towline at varying depths in the water. Preferably, the tethering arrangement is located along an upper portion of the body at or adjacent the front end of the body to enable the body to be lowered into the water during towing.

The teaser may be any size or shape. Generally, the shape of the teaser will be substantially streamlined. As mentioned above, the teaser body comprises a top wall having a length extending between the front and rear ends and a width extending between opposed side walls, the side walls extending downwardly from the top wall. the body further comprises a bottom wall extending downwardly and inwardly from a lower portion of the side walls towards a central longitudinal axis of the body. The body also comprises a bottom wall or a lower side wall that that extends downwardly and inwardly from a lower portion of the side walls towards a central longitudinal axis of the body. The width of the top wall is greater than the height of the side walls to present a flattened and streamlined structure for the body of the teaser.

In some embodiments, the body may be a unitary body. In other embodiments, the body may comprise one or more body portions. The one or more body portions may include a first body portion, a second body portion and a third body portion. At least one of the first body portion, the second body portion and the third body portion may be in the form of a frame portion for providing structure to the teaser body. At least one of the remaining body portions may be in the form of a first side portion, and the remaining body portion may be in the form of a second side portion. The frame portion may be positioned between the first side portion and the second side portion and adapted to provide structural support to both the first and second side portions.

The body may be made from any suitable material for spending prolonged times in water. In some embodiments, the body, or portions of the body, may be made from, or substantially made from, a polymeric and/or plastic material. In some embodiments, the body, or side portions of the body, may be made from a foam material. The foam material may be in the form of a closed cell foam material. Advantageously, the closed cell foam material provides buoyancy and/or absorbs shock if an external item impacts the body.

The body may be manufactured using any suitable technique. Preferably, the body or portions of the body, may be rotomolded, injection moulded and/or formed.

The body may be in the form of a housing for housing one or more components, in the form of one or more electronic components. Accordingly, the body may be suitably sized or shaped for housing the one or more components. Preferably, the body will be substantially elongate.

The body may include one or more recesses for receiving one or more components, for example, a light source. Each recess may be in the form of an elongate recess. In some embodiments, at least one recess may extend along the length of the body. In some embodiments, at least one recess may extend along the width of the body.

The body may include a forward end, a rear end, and at least one side wall extending in between the forward end and rear end. The forward end and/or the rear end may include at least one mounting arrangement. The rear end may include one or more fins.

The body may define a cavity for receiving the one or more components. In some embodiments, the cavity may be defined by one or more portions which form the body. More specifically, the cavity may be formed by the first side portion, the second side portion and/or the frame portion of the body. The cavity may be centrally located within the body. The cavity may be adapted to fill with a liquid when submersed therein.

The body may define a one or more open ended apertures adapted to allow liquid to fill or drain from the cavity. In some embodiments, each aperture may be defined by the at least one sidewall. In some embodiments, each aperture may be defined by the frame portion and/or the side portions of the body. Each aperture may be in the form of a drainage aperture for draining fluid from the cavity and/or for flushing the cavity after use.

The body may include at least one mounting surface for mounting the one or more light sources. In some embodiments, the body may include a pair of mounting surfaces for mounting the at least one light source.

The body may include an outer surface and an inner surface. Each mounting surface may form part of the outer surface of the body.

The body may include a lower portion for resting below the surface of the body of water when not being towed and an upper portion for resting above the surface of the body of water when not being towed.

Turning to the at least one light source, the at least one light source may include a single light or multiple lights. The multiple lights may be in the form of an array of lights or a strip of lights. A skilled person would understand that the array of lights may be arranged in any suitable pattern.

The at least one light source may extend along a length of the body. The at least one light source may extend along a width of the body. In most embodiments, at least one of the at least one light source may extend along the at least one side wall. The at least one light source may be positioned at or towards the front of the body. The at least one light source may be positioned along the side of the body. The light source may be included at the rear of the body as well in some embodiments.

The at least one light source may be programmed to operate in multiple patterns and/or at varied intensities. The at least one light source may be programmed to operate at different flashing rates. The at least one light source may be programmed to operate at different intensities and/or intensity patterns.

The at least one light source may include one or more groupings of light sources. In some embodiments, the one or more groups may be current controlled by a light emitting diode (LED) driver integrated circuit. The LED driver integrated circuit may be in the form of a feedback controlled current source. In some embodiments, each group of lights may be controlled by a single control line. In some embodiments, a hemisphere of water surrounding the teaser may be divided into one or more segments. Each segment may be defined by a range of angles. Each segment may be associated with a group of one or more light sources. In some embodiments, each group of one or more light sources may be activated in a staggered or round robin fashion.

Typically, each light source is mounted to, or extends from, the outer surface of the body. In some embodiments, the at least one light source may be mounted to the body. In some embodiments, each light source may be mounted to a mounting plate for mounting each light source relative to the body.

The at least one light source may be in the form of one or more LED lights, halogen lights or similar.

In some embodiments, each light source may be covered by one or more lenses. Each lens may bend the light of each light source fore, aft, up and down. Each lens may be made from a plastic material. Each lens may be adapted to have air on one side and plastic on the other. Each lens may be adapted to maximise the amount of light captured by the at least one light source. Each lens may be in the form of a round porthole in an aluminium plate. Each lens may be adapted to be sealed to keep any internal electrical components dry.

Preferably, the at least one light source is connected to at least one power source. The at least one power source may be in the form of an internal power source and/or an external power source.

The teaser may further include a mounting member for mounting the at least one light source relative to the body. The mounting member may be any size or shape. Typically, the mounting member is shaped to match at least a portion of the outer surface of the body. Typically, the mounting member will be substantially U- or V-shaped.

Mounting member may include at least one inclined surface for mounting the at least one light source. Preferably, the mounting member includes a pair of inclined surfaces for mounting the at least one light source.

The mounting member may include at least one attachment surface for attaching the mounting member to the body. Preferably, the mounting member includes a pair of attachment surfaces.

The mounting member may be attached to the body using any suitable attachment arrangement, for example, one or more rivets, glue or similar. In most embodiments, the mounting member may be detachably mounted to the body.

Advantageously, components received within the cavity may be accessed. In alternative embodiments, the mounting member may be permanently mounted to the body. The mounting member may be in the form of a mounting plate.

The teaser may further include at least one internal power source. Advantageously, the internal power source may act as a primary power source for powering the at least one light source. Alternatively, the internal power source may act as a secondary power source for when a primary power source is unavailable.

Each internal power source may be received within the cavity of the body. The at least one internal power source may be in the form of one or more batteries.

The teaser may further include a power cord for connecting the at least one light source to an external power source. Preferably, the external power source may be located on the boat to with the teaser is tethered. The power cord may extend from the body. In some embodiments, the power cord may extend from the rear end of the body, at/or towards a lower of the rear end of the body. In other embodiments, the power cord may extend from the front of the body. At least a portion of the power cord may be received within a channel formed from by the mounting plate. In other embodiments, the power cord may extend from the front end of the body, at/or towards an upper, front end of the body. In some embodiments, the power cord may be connected to a tether, preferably in intervals.

The teaser may further include a tether for tethering the body to a boat. The tether may be in the form of a tow line. The tow line may be in the form of a rope, wire, line or similar. Advantageously, the teaser may be towed behind a boat using the tether. Typically, the tow line may support the power cord. Alternatively, the tether may be in the form of the power cord.

The tether may include a first end for mounting the tether to the body of the teaser and a second end for mounting to the tether to a boat. The first end may be adapted to receive a fastener for fastening the tether to the body of the teaser. In some embodiments, the tether includes an eyelet for receiving a fastener.

The tether may be mounted at or towards the front of the body of the teaser. The tether may be attached to a front mounting arrangement of the teaser using a fastener. Preferably, the tether is releasably mounted to the mounting arrangement such that the position of the tether relative to the body of the teaser may be adjusted. Advantageously, the teaser may be towed at different depths.

The teaser may further include a hydroplane or hydrofoil. In most embodiments, the hydroplane is located below water level when the teaser is not being towed. Advantageously, the hydroplane forces or drags the body under water when at the time of towing and/or once towing is commended. The hydroplane may be mounted to the body of the teaser. The hydroplane may be mounted to the body of the teaser using at least one fastener. The hydroplane may be pivotally mounted relative to the body of the teaser. Preferably, the hydroplane is mounted to the body of the teaser at/or towards the front of the body. The hydroplane may be attached to a front mounting arrangement of the teaser using a fastener. Preferably, the hydroplane is mounted to a lower portion of the body of the teaser. Preferably, the hydroplane is mounted relative to the body below a mounting point of the tether. Advantageously, when in use, the hydroplane may counter the upward pull of the tether whilst enabling the body to trail in a horizontal position. In addition, positioning the hydroplane under the tether allows the hydroplane to assist in pulling the body under the surface of the water. Preferably, the hydroplane is adjustably mounted to the mounting arrangement such that the angle of the hydroplane relative to the body of the teaser may be adjusted and in turn adjusts the depth of the teaser. In some embodiments the hydroplane is spring mounted such that, in use, the teaser reaches and/or maintains a predetermined depth at a predetermined speed. In other embodiments, the height adjustment may be carried out by using a bolt. Advantageously, the teaser may be towed at different depths to manage the stability of the teaser under tow and in particular with respect to prop wash.

The teaser may further include one or more mounting arrangements. The one or more mounting arrangements may include a first mounting arrangement for mounting a hydroplane and/or tether; a second mounting arrangement for mounting an electronic device, such as a camera or a sonar; a third mounting arrangement for mounting the other of the hydroplane or the tether; a fourth mounting arrangement for mounting an upper bracket; and/or, a fifth mounting arrangement for mounting for mounting one or more weights. The first and/or third mounting arrangement may be in the form of a front mounting arrangement located at or toward the front of the body. The second mounting arrangement may be in the form of a rear mounting arrangement located at or towards the rear of the body.

The fourth and/or fifth mounting arrangements may be in the form of an upper mounting arrangement and lower mounting arrangement, respectively. Each fourth and/or fifth mounting arrangement may extend along the length of the body. The fourth and/or fifth mounting arrangements may each include a pair of spaced apart apertures for mounting one or more accessories to the body. For example, one or more weights may be mounted to the bottom of the body using the lower mounting arrangement. Advantageously, attaching one or more weights in this manner lowers the centre of mass of the body which aids in stability and/or assists in controlling the depth of the body.

Each of the first, second and/or third mounting arrangements may include a rib extending from an outer surface of the body. Each rib may include one or more apertures, adapted to receive a fastening member, for example a D-shackle, bolt, pin or similar, for fastening a hydroplane, tether, camera and/or sonar or similar accessory relative to the body.

Each mounting arrangement may be integrally formed with the body. The frame portion of the body may define each of the mounting arrangements.

The teaser may further include one or more panels. In some embodiments, each panel may be in the form of a reflecting panel for reflecting light. Each panel may be positioned on the outer surface of the body. Preferably, each panel may be positioned on an outer, upper surface of the body for reflecting light. Each panel may be may of any material suitable for reflecting light. Typically, each panel will be in the form of a reflector strip. Each panel may be of a predetermined colour. Advantageously, different coloured panels may be used to lure different species of fish.

The teaser may further include one or more fins adapted to stabilize the body. Preferably, the one or more fins stabilize the body in an upright orientation when being towed through a body or water and/or when floating at the surface of the body of water. Preferably, the one or more fins are adapted to assist in preventing rotation of the teaser when being towed through the body of water. In a preferred embodiment, the teaser comprises a vertical tail fin along the rear end of the body and extending upwardly from an upper portion of the body. The teaser may also comprise opposed horizontal fins located at the rear end of the body, the horizontal fins extending laterally and outwardly from the body in a transverse direction relative to the direction of movement of the teaser body.

In most embodiment, the one or more fins extend outwardly from the body. Preferably, the one or more fins extend outwardly from the at least one side wall of the body. In most embodiments, the teaser includes three fins, in the form of an upper and a pair of lower fins. The pair of lower fins may each extend from an opposite side of the body. The one or more fins may be integrally formed with the body. At least one of the one or more fins may extend outwardly from each of the frame, first side and/or second side portions of the body.

The teaser may further include shock absorbing panels for covering at least a portion of the body. In other embodiments, the body itself may be formed from shock absorbing material such as shock absorbing foam. The cover may be in the form of shock absorbing foam for protecting the surface of the body advantageously, the panel may protect the body from external impacts, for example fish attacks and/or collisions with other objects.

The teaser may include a fastening arrangement for fastening the first body portion and/or the second body portion to the frame portion. The fastening arrangement may include one or more fasteners, each fastener adapted to be received within at least one aperture defined by the first side portion of the body or the second side portion of the body, and at least one corresponding aperture in the frame portion of the body. The one or more fasteners may be any suitable fastener known in the art, for example one or more screws or similar. Advantageously, the side portions are removable from the frame portion such that a cavity defined by the body may be accessed.

The teaser may further include a float attachment. In some embodiments, the float attachment may be mounted to the body of the teaser using one of the mounting arrangements. More specifically, in some embodiments, the float attachment may be mounted to the body of the teaser using the front mounting arrangement.

The teaser may include one or more weight attachments. In some embodiments, the weight attachment may be mounted to the body of the teaser using one of the mounting arrangements. More specifically, in some embodiments, the weight attachment may be mounted to the body of the teaser using the rear mounting arrangement.

In some embodiments, a float attachment may be mounted to the body of the teaser at one end and a weight attachment mounted to the body of the teaser at the opposite ends. Advantageously, the teaser need not be towed by a water vessel but allowed to float and/or drift in the body of water when drift fishing methods are used.

The teaser may further include a bracket attachment for attaching the teaser to water vessel, boat or similar. In some embodiments the bracket attachment may be attached to one of the mounting arrangements. In most embodiments, the bracket attachment may by mounted to the upper mounting arrangement. Advantageously, the teaser may be used as underwater boat lighting, for example, for use when boats are moored for decorative purposes or when boats are moored for attracting bait fish and squid.

The teaser may include at least one sensor. The at least one sensor may be in the form of a temperature sensor for detecting if the internal temperature of the teaser exceeds a predetermined temperature. In some embodiments, once the temperature of the teaser exceeds a predetermined temperature the teaser cuts current to the at least one light source. Advantageously, overheating of the teaser is avoided and/or any damage caused by overheating.

In an embodiment, the body comprises a plurality of groups of lights, each group of light being arranged along a specific region of the body such that respective segments of a hemisphere of water surrounding the submerged teaser body receive light from a corresponding group of lights.

In another aspect, the present invention resides in a method for operating a teaser for attracting fish, the teaser including at least one light source and at least one microprocessor adapted to control the at least one light source, the method including the steps of:

programming the microprocessor to operate the at least one light source in a predetermined manner.

In some embodiments, the programming step may include programming one or more modes of operation. In some embodiments, the one or more modes of operation may include a low power mode, a power saver mode, and/or one or more operational modes.

In another aspect, the present invention broadly resides in a teaser for attracting fish, the teaser comprising: a body; and at least one light source.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

The Detailed Description will make reference to a number of drawings as follows:

FIG. 1 shows a front, isometric view of a fish teaser 100 in accordance with a first preferred embodiment of the present invention.

FIG. 2 shows a back, isometric view of the fish teaser 100.

FIG. 3 shows a top view of the fish teaser 100.

FIGS. 4A and 4B show left and right side views of the fish teaser 100.

FIG. 5 shows a bottom view of the fish teaser 100.

FIG. 6 shows a first back view of the fish teaser 100 without the camera 109.

FIG. 7 shows a second back view of the fish teaser 100 with the camera 109.

FIG. 8 shows a first front view of the fish teaser 100 with the towline attached.

FIG. 9 shows a front, isometric view of a fish teaser in accordance with a second preferred embodiment of the present invention.

FIG. 10 is an exploded view of the fish teaser 100.

### DETAILED DESCRIPTION OF PREFERRED EMBODIMENTS

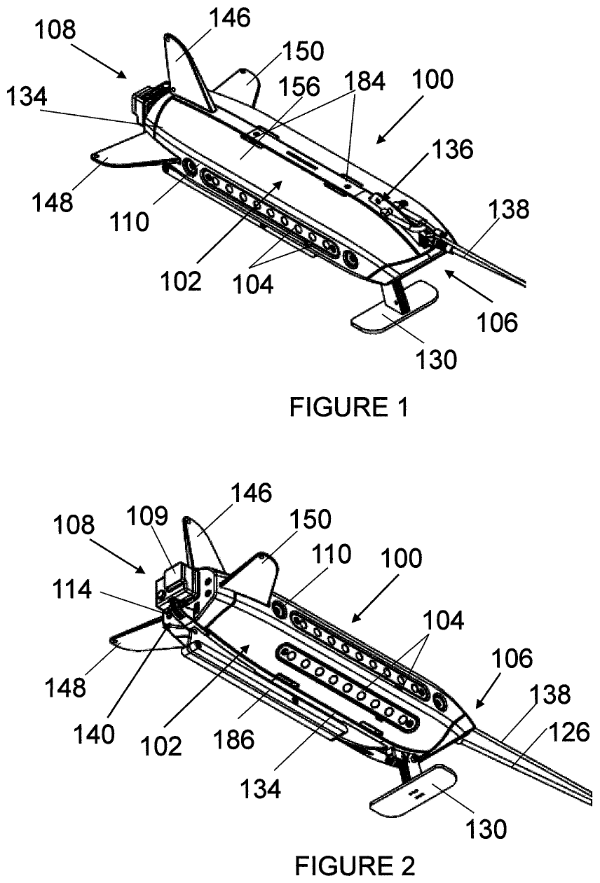

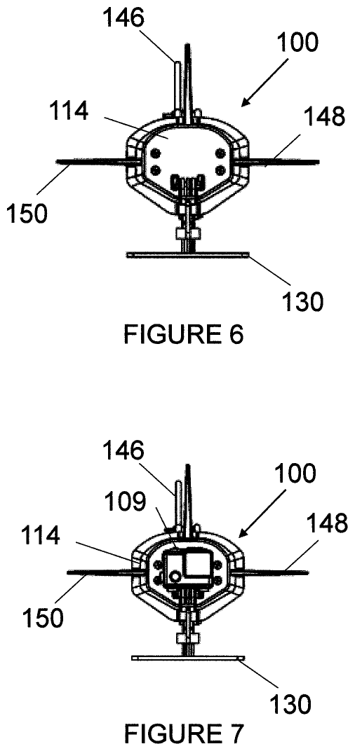

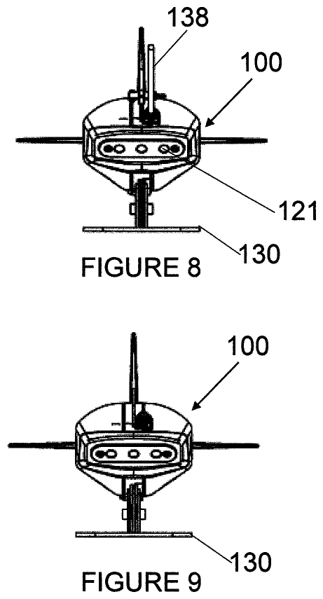

FIGS. 1 to 10 show a teaser 100 for attracting fish in accordance with a preferred embodiment of the present invention. Teaser 100 comprises a body 102, and at least one light source, in the form of lights 104, for attracting fish.

In the preferred embodiment shown, teaser 100 is positively buoyant. As such, teaser 100 is adapted to rise to the surface of a body of water when not being towed. Advantageously, if teaser 100 is separated from a boat during use, then the teaser will simply float to the surface of the body of water for easy retrieval.

As previously discussed, the teaser 100 includes the body 102. In the preferred embodiments shown, body 102 is a unitary body made from a rotomolded material, such as high density urethane or Polyethylene (PE). A skilled person would understand that in alternative embodiments, body 102 may be formed using any known manufacturing technical, such as injection moulding, and from any other material suitable for exposure to a body of water, particularly salt water.

As can best be seen in FIGS. 1 to 5, body 102 is substantially elongate, and includes a front end 106, a rear end 108, and a side wall 110 extending in between the front end and the rear end. A camera mounting location 114 is formed in rear end 108 for locating camera 109 (best shown in FIGS. 2 and 7). A skilled person would understand that a sonar or other similar device may located in the camera mounting location 114 instead of or in addition to camera 109.

Side wall 110 defines an opening for accessing a cavity for receiving electrical components of teaser 100. The opening is defined by a lower portion of body 102.

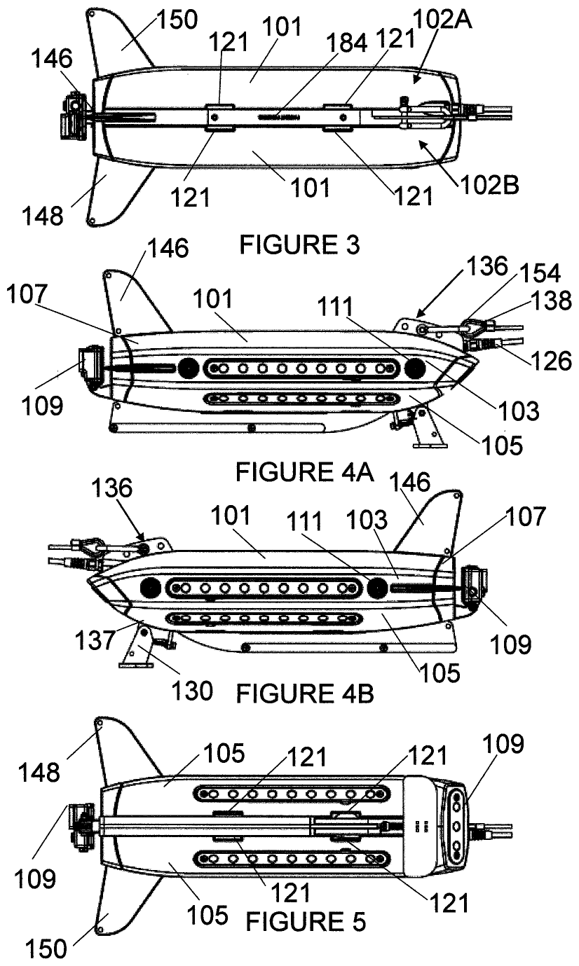

Referring to FIG. 10 and FIGS. 3 to 5, the elongate body 102 comprises a first side portion 102A, a second side portion 102B and central frame portion 102C. In this embodiment, each side portion (102A or 102B) includes an upper surface 101, a pair of opposite side surfaces 103, a lower surface 105, a rear facing surface 107 and a forward-facing surface 109. Side surfaces 103 extend relatively downward from outer edges of upper surface 101. Lower surface portions 105 extend relatively from a lower edge of the opposite side surfaces 103 respectively, diverging inwardly towards central portion.

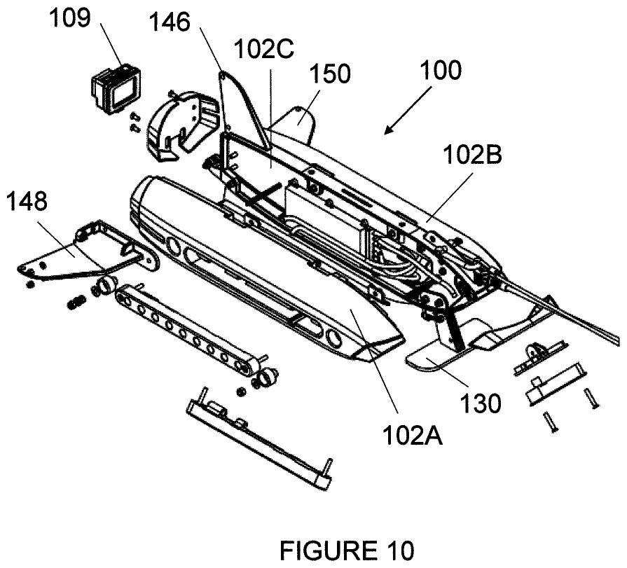

Referring once again to FIG. 10, teaser 100 further includes a fastening arrangement for fastening the first side portion 102A and second side portion 102B to frame portion 102C. The fastening arrangement includes screws 111 which partially extend through the width body 102. Each screw 111 is adapted to be received within apertures formed in either the first side portion 102A or second side portion 102B and secure each of the respective side portions to frame portion 102C. As can be best seen in FIG. 10, each screw 111 is fastenable to frame portion 102C.

The teaser 100 includes a rear mounting arrangement 140 for mounting camera 109, and a front mounting arrangement 136 for mounting tether 138 and hydroplane 130 relative to body 102.

Lights 104 extend along recessed portions of the upper and lower side surfaces 103 and 105. An array of lights is formed from lights 104 grouped together and spaced apart along the length of the upper and lower side surfaces 103 and 105 within channels provided on these side surfaces. In the preferred embodiment shown, the array of lights may be programmed to operate and/or flash in multiple different patterns and/or at different flashing rates using a microprocessor located in the cavity of body 102. Advantageously, lights 104 are programable to flash or alternate in different patterns to depict different bait species, bait balls, and/or larger bait fish to attract different predatory fish species.

In use, groups of light emitting diode (LED) lights operate in voltage mode whereby the LEDs operate at a supplied voltage. MOSFETS are preferably used for controlling the operation of the LEDs. The hemisphere of water that teaser 100 is emersed in is divided into several solid angles each of which will be associated with a group of LED lights in series. The groups of LED lights in series flash the same pattern in a staggered fashion. Advantageously, the load on the power supply will be more evenly disturbed, thus minimizing peak load and maximising effect.

In the preferred embodiment shown lights 104 are connected to a power source, in the form of an external 12V or 24V power source, via power cord 126. A skilled person would understand that any suitable power source, for example a 36V or 48V power source, may be used. In most preferred embodiments, the power source will be less than 48V for safety purposes. Power cord 126 extends from front end 106 of body 102. In alternative embodiments, lights 104 may be connected to an internal power source located in the cavity of the body 102.

Teaser 100 further includes the front mounting arrangement, in the form of a rib 136, for detachably mounting tether 138 and hydroplane 130 to body 102. Rib 136 extends from a frontal outer surface of body 102, and includes multiple apertures, each for receiving a fastener for example a D-shackle, bolt, pin or similar, for fastening tether 138 and/or hydroplane 130 thereto.

As best shown in FIG. 2, teaser 100 further includes rear mounting arrangement, in the form of a protrusion 140, for mounting a camera, sonar or similar electronic device. Protrusion 140 includes an aperture for receiving a fastener for fastening camera 109 to rear end 108 of body 102.

Teaser 100 further includes fins, in the form of an upper fin 146 and a pair of lower fins 148, 150. Fins 146, 148 and 150 extend from the outer surface of body 102. Each fin 146, 148 and 150 is substantially elongate and extends along the length of body 102 starting at or towards rear end 108 and extending towards front end 106. As best shown in FIGS. 1 and 2, upper fin 146 extends upwardly from an upper surface of body 102, while lower fins 148, 150 extend outwardly from side surfaces of body 102 in opposite directions to one another. Advantageously, fins 146, 148 and 150 assist in stabilizing teaser 100 when being towed by a boat.

As best shown in FIG. 1 and FIG. 2, each of rib 136, protrusion 140 and fins 146, 148 and 150 are integrally formed with body 102 of teaser 100. However, the ribs 136, the protrusion 140 and the fins 146, 148 and 150 may be attached to the body 102.

Teaser 100 further includes hydroplane 130. Advantageously, hydroplane 130 forces body 102 under water when teaser 100 is being towed by a boat. Hydroplane 130 is mounted below tether 138 to the lower side surface 105 of the body 102 using a fastener, in the form of a bolt (best shown in FIGS. 4A and 4B).

Teaser 100 further includes tether 138 (or tow line) for tethering the body to a water vehicle, for example a boat, jet ski, or other similar fishing vessel. In preferred embodiments, tether 138 may be in the form of a rope, wire, line or similar. Advantageously, teaser 100 can be towed behind a boat using tether 138. While not shown, tether 138 may be used to support power cord 126.

Tether 138 is mounted to rib 136 using fastener, in the form of D-shackle 154, and includes a first end for mounting the tether to housing 102 and a second end for mounting to the tether to a boat. In the preferred embodiment shown, at least the first end includes an eyelet for receiving the fastener for fastening tether 138 to rib 136.

In the preferred embodiment shown, both tether 138 and hydroplane 130 are securable to mounting structures 136 and 137 via any one of apertures provided on the mounting structures. Advantageously, teaser 100 may be configured to be towed at different depths.

As shown in FIGS. 1 to 5, teaser 100 includes a power cord 126 for connecting lights 104 to an external power source (not shown). Power cord 126 extends from front end 106.

The teaser 100 may further include reflecting panels 156. In the embodiment shown, panels 156 are reflecting panels for reflecting light. Each reflector panel 156 may be positioned on the outer surface of an upper portion of housing 102 for reflecting sunlight from above. Each reflector panel 156 is made of any material suitable for reflecting light. A skilled person would understand that panels 156 are not limited to being reflective panels. In alternative embodiments, panels 156 can be non-reflective panels. Furthermore, in alternative embodiments, panels 156 can be any predetermined colour.

The teaser further may include drainage holes 121. Drainage holes 121 may be formed in upper and lower surfaces side surfaces 103 and 105 of for each body part 102A and 102B. The drainage holes 121 may be spaced apart along the length of body 102. A skilled person would understand alternative embodiment may include any number of drainage holes without departing from the spirit of the invention.

Turning to FIG. 10, a more detailed view of frame portion 102C is shown therein. Frame portion 102C includes an internal wall extending along the length and width of body 102, and a rib that extends around the periphery of the wall. The rib extends substantially perpendicular to wall in both directions to form an outwardly extending lip on either side of wall.

As best shown in FIGS. 1 and 2, teaser 100 may further comprises an upper mounting arrangement 184 for mounting an accessory, for example a bracket (not shown) or float (not shown) to body 102, and a lower mounting arrangement 186 for mounting another accessory, for example one or more weights (not shown) to body 102.

In the preferred embodiments shown in FIGS. 1 to 10, side portions 102A, 102B are made from a closed cell foam material. Advantageously, the closed cell foam material provides buoyancy and/or absorbs shock if an external item impacts the body. Further, frame portion 102C is made from a rigid plastic material. Advantageously, frame portion 102C provides structural support to other portions of the body.

The teaser 100 described above and shown in the accompanying Figures includes a set of operational buttons or switches (not shown), including an ‘on/off’ button and a ‘mode’ button for changing modes. In the preferred embodiments, the buttons are located on a control box located on the boat/vessel. The mode button is used to cycle through different modes, such as low power mode and/or power saver mode and/or one or more operational modes, once teaser 100 has been turned on. In alternative embodiments, a single ‘on/off’ button can act to turn the teaser on, switch between modes, and to turn the teaser off.

Use of the teaser 100 will now be described below.

When teaser 100 is switched on using the ‘on/off’ button, teaser 100 switches from off to on. Once on, teaser 100 automatically enters a full brightness mode in which the lights operate at their full brightness capacity. In some instances, the teaser 100 may be left on for a variety of reasons which can cause overheating of the circuit-boards on which the LEDs are mounted. Each circuit-board comprises a temperature sensor that can sense such overheating. The sensors report the temperature back to the microcontroller and when the sensed temperature exceeds a threshold/pre-set temperature, then the power supplied to the LEDs is reduced (by up to 50%) which results in the dimming of the LEDs. Just like the on/off button, a “dim mode reset” button may be provided to reset the microcontroller to toggle the dim mode back to the normal full power working mode and restore the LEDs to full brightness.

As discussed earlier, when in use, teaser 100 is adapted to automatically switch to the low power mode, i.e. with dimmed lights, or to a power saver mode, i.e. wherein the lights are dim but the device is still on and operating at 50% power, when the temperature of the device is raised beyond a predefined temperature. Advantageously, the device is allowed to cool down, thus minimising the risk of a user picking up a hot device and/or overheating the device. To prepare the device for redeployment into the water, the reset button is pressed which changes the mode from a power saver mode to a fully operational mode.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A trolling teaser for trolling and attracting fish, the teaser comprising:
an elongate body extending between a frontal end and a rear end, wherein the front end comprises a tethering attachment to tether the body to a towline and allow the teaser to be towed;
one or more light sources mounted to the body for radiating light and attracting fish; and,
a programmable light source controller housed within an internal volume of the body for controlling operation of the at least one light source.

2. The trolling teaser in accordance with claim 1, wherein the body of the teaser is positively buoyant in water when the teaser is not being towed by the tow line and wherein the tethering attachment attaches the tow line at an attachment location to substantially lower the body of the teaser into water when the teaser is being towed by the towline behind a vessel pulling the towline.

3. The trolling teaser in accordance with claim 1, wherein the tethering attachment enables attachment of the towline at a plurality of attachment locations thereby allowing the body of the teaser to be towed by the towline at varying depths in the water.

4. The trolling teaser in accordance with claim 1, wherein the centre of buoyancy of the body is above the centre of mass of the body thereby allowing the body to be positively buoyant when not being towed by the towline.

5. The trolling teaser in accordance with claim 1, wherein the tethering arrangement is located along an upper portion of the body at or adjacent the front end of the body to enable the body to be lowered into the water during towing.

6. The trolling teaser in accordance with claim 1, wherein the body comprises a top wall having a length extending between the front and rear ends and a width extending between opposed side walls, the side walls extending downwardly from the top wall; wherein the body further comprises a bottom wall extending downwardly and inwardly from a lower portion of the side walls towards a central longitudinal axis of the body; wherein the width of the top wall is greater than the height of the side walls to present a flattened and streamlined structure for the body of the teaser.

7. The trolling teaser in accordance with claim 6, wherein the body comprises two body portions connected to an internal body frame, each body portion comprising respective portions of the top wall, side wall and bottom wall.

8. The trolling teaser in accordance with claim 1, further comprising a hydroplane that is attached at or adjacent the front end of the body; wherein the hydroplane is removably attached to the body to locate the hydroplane below the centre of buoyancy of the body; wherein the hydroplane is attached below the tethering attachment preferably along a bottom wall portion of the body to counter pull of the towline and enable the body to trail in a substantially horizontal position.

9. The trolling teaser in accordance with claim 8, wherein the hydroplane is adjustably mounted along the body to vary the angle of the hydroplane relative to a lower portion of the body and thereby adjust the wading depth of the teaser body when towed.

10. The trolling teaser in accordance with claim 1, wherein the body further comprises an upper mounting arrangement located along an upper portion of the body for mounting accessories to the body.

11. The trolling teaser in accordance with claim 1, wherein the body further comprises a lower mounting arrangement located along a lower portion of the body for mounting additional weights to the body for lowering the centre of mass of the body during towing.

12. The trolling teaser in accordance with claim 1, wherein the body comprises a vertical tail fin located along the rear end of the body and extending upwardly from an upper portion of the body and further comprises opposed horizontal fins located at the rear end of the body, the horizontal fins extending laterally and outwardly from the body in a transverse direction relative to the direction of movement of the teaser body.

13. The trolling teaser in accordance with claim 1, further comprising one or more programmable microprocessors to control operation of said light sources for mimicking bait fish.

14. The trolling teaser in accordance with claim 1, wherein the one or more microprocessors include executable instructions which instruct the at one or more light sources to flash in a predetermined pattern, at a predetermined rate, and/or at a predetermined intensity.

15. The trolling teaser in accordance with claim 1, wherein the body comprises elongate channels extending along the length and/or width of the body, the channels being configured to receive said one or more light sources therein.

16. The trolling teaser in accordance with claim 1, wherein the body comprises one or more liquid receiving portions adapted to fill up with liquid when the body is submerged in liquid; and wherein the body comprises drainage apertures to allow liquid in the liquid receiving portions to drain out of the body.

17. The trolling teaser in accordance with claim 1, wherein the one or more light sources are covered by lenses to bend the light emitted by the light sources.

18. The trolling teaser in accordance with claim 1, further comprising a power cord extending outwardly from the body for connecting the teaser to an external power source; and wherein the power cord extends from the front end of the body.

19. The trolling teaser in accordance with claim 1, wherein the body comprises a plurality of groups of lights, each group of light being arranged along a specific region of the body such that respective segments of a hemisphere of water surrounding the submerged teaser body receive light from a corresponding group of lights.

20. The trolling teaser in accordance with claim 1, wherein the programmable controller is programmable to reduce overheating of the lights by detecting an over-temperature condition and in response to detecting the over-temperature condition, reducing power consumption of the lights thereby reducing brightness of the lights during use.
